(19) United States
(12) Patent Application Publication
(10) Pub. No.: US 2012/0080417 A1
(43) Pub. Date: Apr. 5, 2012

(54) ADJUSTMENT AID FOR A COMPONENT OF A WELDING DEVICE

(75) Inventors: Friedrich Oberzaucher, Wels (AT); Guenther Neubacher, Neukirchen bei Lambach (AT); Micha Mittermair, Pettenbach (AT); Bernhard Eckl, Kirchdorf/Krems (AT); Wolfgang Brunmayr, Wels (AT)

(73) Assignee: FRONIUS INTERNATIONAL GMBH, Pettenbach (AT)

(21) Appl. No.: 13/322,248

(22) PCT Filed: May 28, 2010
(86) PCT No.: PCT/AT2010/000186

§ 371 Date: Nov. 23, 2011

(30) Foreign Application Priority Data
Jun. 18, 2009 (AT) A 943/2009

(51) Int. Cl. B23K 9/32

(52) U.S. Cl. 219/136

(57) ABSTRACT

An adjustment aid (29) for a component of a welding device (1) in the form of an element for mounting or fastening on an input and/or output unit (18) of the component, on which element additionally information (31) and/or scale (32) for adjusting a welding process are printed is provided. In order to simplify the adjustment of a certain welding process by the user, it is provided that the element is formed by a flexible element or foil (30) with two openings (33) for mounting or fastening on two rotary knobs (34) of the input and/or output unit (18), the openings each having a first part (38) and a second part (39), wherein the first part (38) of each opening (33) is designed for guiding through a rotary knob (34) and the second part (39) of each opening (33) is formed for fixation between the two rotational axes (37) of the rotatory knobs (34).

The invention relates to an adjustment aid for a component of a welding device in the form of an element for mounting or fastening on an input and/or output unit of the component, on which element additional information and/or scales for adjusting a welding process are printed.

From prior art, especially US 2008/0149607 A1, systems are known, in which at least one part of the input and/or output unit of a welding device is coated with a transparent layer. Hence, the user has the possibility to use these areas for markings, especially identification marks of an adjustment on a scale of a rotary knob, or for additional information. Therefore, the user is at any time able to readjust the rotary knobs according to said markings and to repeat the welding process quite accurately. By using such a layer the markings can also simply be removed again without scratching or damaging the surface of the input and/or output unit.

U.S. Pat. No. 4,321,587 A presents an adjustment aid for a car radio having an element for mounting or fastening on an input and/or output unit of said car radio.

It is disadvantageous that for various welding processes the user needs to provide a plurality of markings, causing a complexity that might result in misadjustments. Moreover, said markings may also become easily unreadable.

The object of the invention is to provide an adjustment aid for a component of a welding device, by which the adjustment of a certain welding process is simplified. Disadvantages of known systems should be avoided or at least be reduced.

The object is solved in that the element is formed by a flexible element or foil with two openings for mounting or fastening on two rotary knobs of the input and/or output unit, said openings each having a first part and a second part, wherein the first part of each opening is designed for guiding through a rotary knob and the second part of each opening is formed for fixation between the two rotational axes of the rotatory knobs. Here, it is advantageous that by mounting the adjustment aid on an input and/or output unit of the welding device the user is provided with more information and that simultaneously a scale simplified for a certain welding process is employed for the rotary knobs of the input and/or output unit, so that the user is able to make a very simple adjustment. Another significant advantage is that for different welding processes or different welding parameters adjusted scales can always be used for the rotary knobs or potentiometers. Preferably, the foils are removably arranged on the input and/or output unit and can, therefore, be replaced quickly and easily. It is also an advantage that adjustments for new welding programs can be printed on the adjustment aid quite easily without having to change the basic system (such as control panel). It is equally an advantage that thereby a clear operation, a replacement of scales as well as market- or country-specific scales can be realized. Also, client-specific needs regarding parameters to be adjusted on the input and/or output unit can advantageously and easily be met by the adjustment aid. Due to the openings on the flexible element or the foil it can be fastened on the input and/or output device over the rotary knobs without additional holding devices, simultaneously achieving a simple handling. In particular, this is also because the rotary knobs do not need to be removed to fasten the flexible elements or foil, but are simply covered by them. Thus, a loss of rotary knobs can also be excluded.

Here it is advantageous when the first part and the second part of each opening are each designed semi-circular, wherein the diameter of the first part is larger than the diameter of the second part, and the first part is arranged in a mirror-inverted way to the second part.

An advantageous design is achieved in that the flexible element or foil is labeled with information, such as material, e.g. steel, wire diameter, e.g. 1.0 mm, or protective gas, e.g. 100% CO₂, and has a scale adjusted corresponding to the component used. Thereby the user is provided with further additional information, by the help of which he is able to make a simple adjustment. For example, the scale on the flexible element or the foil can be adjusted to the respective market or country, and the required information or measurements used in said country can be indicated.

In one design, in which with the adjustment aid mounted or fastened a scaling for the rotary knobs of the input and/or output unit and a scale on the flexible element or foil can be seen, the user can be provided with an additional scale, wherein the basic configuration of the welding device remains the same. For this purpose the flexible element or foil is preferably designed transparent or partially transparent. Thus, the user also knows which value is actually adjusted as parameter of the rotary knob corresponding to the scaling, or which value on the scale of the adjustment aid corresponds to which value on the scaling on the input and/or output unit.

Finally, also advantageous is a design, in which the scaling is designed such that on both rotary knobs the same value, for example the value of a material thickness of work pieces to be welded in mm is to be adjusted. This way a simplification of the adjustment on the welding device can be achieved.

Further advantageous designs are found in the description. Advantages arising therefrom can also be found in the description.

The present invention is explained in more detail with the help of the attached schematic drawings. In which:

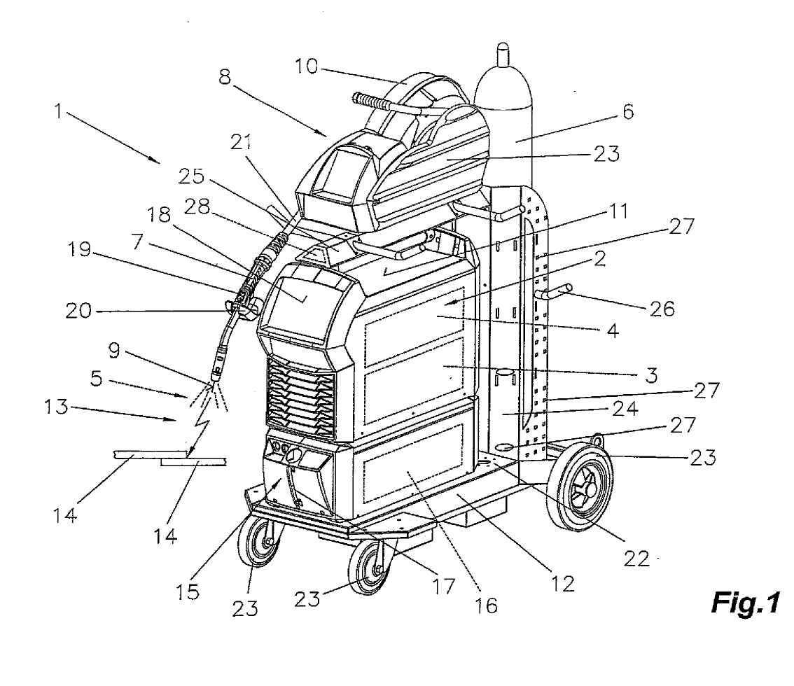

FIG. 1 is a schematic illustration of a welding device;

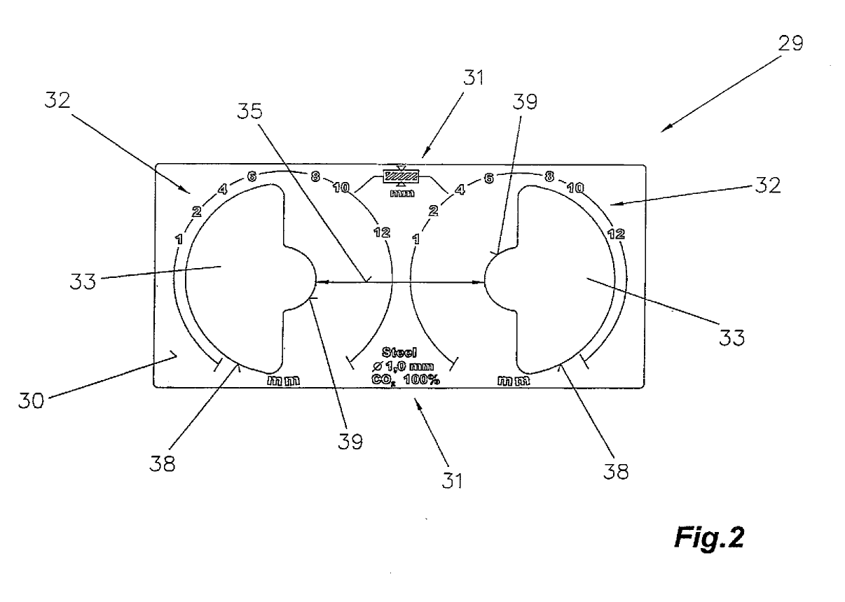

FIG. 2 is a schematic illustration of an embodiment of an adjustment aid according to the invention;

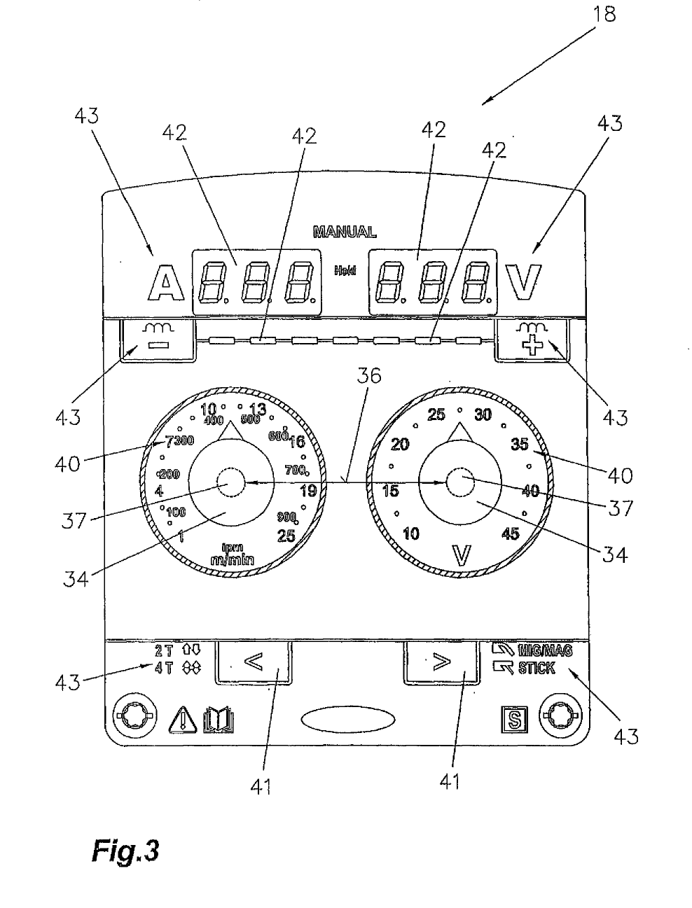

FIG. 3 is a schematic illustration of an input and/or output unit of a welding device; and

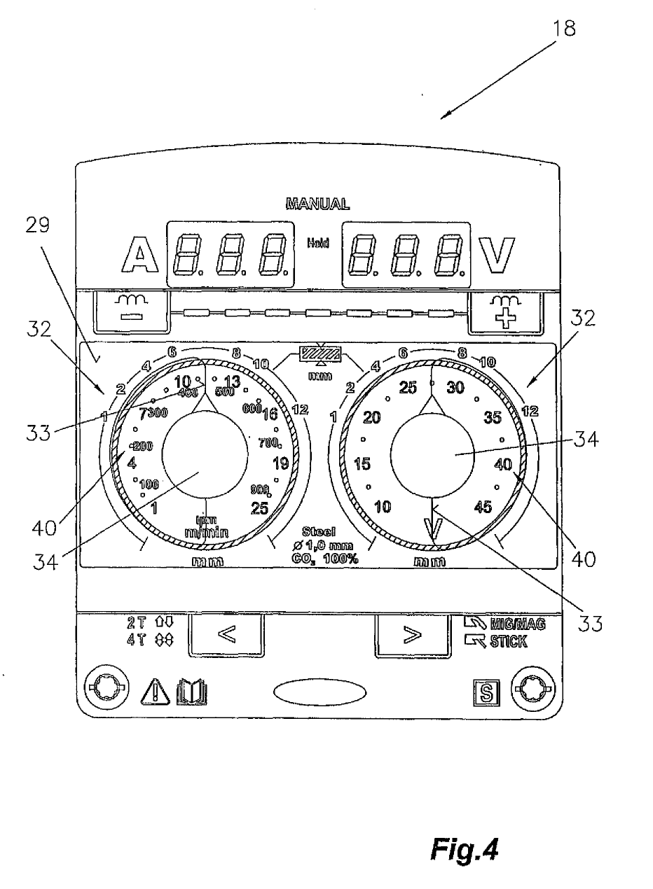

FIG. 4 is a schematic illustration of the input and/or output unit according to FIG. 3 having an adjustment aid according to FIG. 2 mounted or fastened to.

In FIG. 1 a welding device 1 or a welding system for various processes or methods, such as MIG/MAG welding or WIG/TIG welding or electrode welding, twin wire/tandem welding, plasma or soldering processes, etc., is shown.

The welding device 1 comprises a power source 2 having a power element 3, a control device 4 and further components and cables not shown, such as a switchover element, control valves, etc. arranged therein. For example, the control device 4 is connected to the control valve, which is arranged in a supply line for a gas 5, especially a protective gas, such as CO₂, helium or argon and the like, between a gas tank 6 and a welding torch or a blowpipe.

Furthermore, a wire feed unit 8, as usual in MIG/MAG welding, can also be actuated via control device 4, wherein a filler material or a welding wire 9 is supplied from a feed drum 10 or a wire reel into the section of welding torch 7. Of course it is possible to have the wire feed unit 8, known from prior art, incorporated within welding device 1, particularly within housing 11 of power source 2, and not positioned as an additional device on a carriage 12 as shown in FIG. 1. In said case it is spoken of a so called complex welding device 1. It is also possible to mount the wire feed unit 8 directly on welding device 1, i.e. the housing 11 of power source 2 is on the surface thereof designed to receive the wire feed unit 8, so that carriage 12 can be omitted.

It is also possible that the wire feed unit 8 supplies welding wire 9 or filler material outside the welding torch 7 to the working position, wherein within the welding torch 7 preferably a non-consumable electrode is arranged as usual in WIG/TIG welding.

The power for creating an electric arc 13, particularly a working arc, between the electrode or the welding wire 9 and one work piece 14 preferably formed of one or more parts is supplied via a welding cable, not shown, from the power element 3 of power source 2 to welding torch 7, particularly the electrode or welding wire 9, wherein the work piece 14 to be welded is connected with power source 2, not shown, via a further welding cable for further potential, particularly the ground cable, and, thus, an electric circuit can be created for a process via arc 13 or the plasma jet formed. Using a torch having an internal electric arc 13 both welding cables, not shown, are supplied to the torch, so that a respective electric circuit can be created within the torch like with plasma torches.

In order to cool welding torch 7, the welding torch 7 can be connected via a cooling device 15 by interconnection of potential components, such as a flow controller, to a liquid reservoir, particularly a water reservoir 16 with level meter 17, whereby during initial operation of welding torch 7 the cooling device 15, particularly a liquid pump used for the liquid arranged in the water reservoir 16, is started and, thus, a cooling of welding torch 7 can be effected. As seen in the embodiment shown, the cooling device 15 is positioned on the carriage 12, followed by power source 2. The individual components of the welding system, i.e. power source 2, wire feed unit 8 and cooling device 15, are designed such that they have respective projections or openings, so that they can be stapled or put on top of each other.

Furthermore, welding device 1, particularly power source 2, has an input and/or output unit 18, by means of which unit various welding parameters, operation modes or welding programms of welding device 1 can be adjusted or selected and displayed. Welding parameters, operation modes or welding programs adjusted with the help of that input and/or output unit 18 are forwarded to control device 4, and the individual components of the welding system or welding device 1 are then actuated, or respective values for regulating or controlling are provided from this unit. It is also possible that using an adequate welding torch 7 even adjustment procedures can be done via welding torch 7, wherein welding torch 7 is thereto equipped with a welding torch input and/or output unit 19. Preferably, the welding torch 7 is connected to the welding device 1, particularly power source 2 or wire feed unit 8 via a data bus, particularly a serial data bus. In order to start the welding process the welding torch 7 has in most cases a start switch, not shown, so that by pressing said start switch the electric arc 13 can be ignited. In order to be protected from the intense heat of electric arc 13 it is possible to equip the welding torch 7 with a protective heat shield 20.

Furthermore, in the embodiment shown the welding torch 7 is connected to welding device 1 or welding system via a hose package 21. In the hose package 21 the individual cables, such as supply cable or cables for welding wire 9, for gas 5, for cooling circuit, for data transfer, etc., are arranged from welding device 1 to welding torch 7, whereas the ground cable is preferably connected to power source 2. The hose package 21 is connected to power source 2 or wire feed unit 8 via a coupling device, not shown, whereas individual cables within hose package 21 are fastened with a bend protection on or in welding torch 7. In order to ensure an adaquate stress relief of hose package 21 the hose package 21 can be connected to housing 11 of power source 2 or wire feed unit B via a stress relief unit, not shown.

Basically, it should be mentioned that for different welding methods or welding devices 1, such as WIG devices or MIG/MAG devices or plasma devices, not all components previously mentioned need to be used or employed. So, it is for example possible that welding torch 7 can be embodied as an air-cooled welding torch 7, so that for example cooling device 15 can be omitted.

As shown in the embodiment of FIG. 1 carriage 12 is designed for receiving welding device 1 and consists of a base plate 22, to which four wheels 23 are fastenend, wherein the base plate is designed for receiving a welding device 1 or cooling device 15, wherein respective openings, guides, projections might be provided. Furthermore, a holding device 24 for fastening a gas bottle or gas tank 6 on base plate 22 is arranged. Parallel to base plate 22 an adjustment plate 25 for receiving an external wire feed unit 8 is arranged, wherein said adjustment plate 25 is connected to holding device 24. Furthermore, it is possible that next to the elements mentioned above still further components can be arranged on carriage 12, such as a holding element, not shown, additionally mounted to the base plate 22.

On holding device 24 an optional support 26 for receiving and storage of welding components, such as welding torch 7, hose package 21, box of spare parts, storage shelf, etc. is fastened. On said holding device 24 or on a holding element provided for this purpose respective receiving elements 27 are provided. Said receiving elements consist e.g. of several slots, holes, notches, projections, etc., and are designed for receiving the optional support 26. Said optional support 26 is for example designed in the form of a heel preferably for receiving the hose package 21, wherein, however, any other form and design can be used. It is possible that the user is free to choose where he positions the various optional supports 26 and what type of optional supports 26 he employs and wants to carry along on carriage 12. The optional support 26 is for example designed in the form of a box, a storage shelf, a bag, cassette, heel, etc., which can be inserted in one or more receiving elements 27 in a simple way. Hence, free organization of carriage 12 is possible. Furthermore, it is possible that on carriage 12 a carriage input and/or output unit 28 can be provided, wherein in this case carriage 12 is connected to welding device 1, particularly to data bus or control device 4, so that adjustments can be accepted and processed via the carriage input and/or output unit 28.

The input and/or output device 18 of welding device 1 can respectively be arranged on the components of welding device 1, such as power source 2, wire feed unit 8 and/or a remote control.

In FIG. 2 an embodiment of an adjustment aid 29 for the input and/or output unit 18 according to FIG. 3 is shown. In FIG. 4 the input and/or output unit 18 according to FIG. 3 with adjustment aid 29 according to FIG. 2 arranged thereto is shown. Said adjustment aid 29 is designed in the form of a flexible element or a foil 30 for mounting or fastening on input and/or output unit 18 of a welding device 1 or other input and/or output devices 18, such as wire feed unit 8 or other components.

On the flexible element or the foil 30 additionally information 31 and scale 32 for adjusting of for example two parameters of a welding process are printed. The flexible element or the foil 30 is preferably between 0.15 mm and 0.2 mm thick so that it can be bent simply.

The flexible element or the foil 30 of adjustment aid 29 has openings 33 so that foil 30 can be mounted over rotary knobs 34 on the input and/or output unit 18 as shown in FIG. 4. In the embodiment shown in FIG. 2 two openings 33 are intended for two rotary knobs 34. The distance 35 between both openings 33 is dimensioned such that it is slightly larger than a distance 36 between the rotational axes 37 of rotary knobs 34 of the input and/or output unit 18 (see FIG. 4). Preferably, the openings 33 have a special form, wherein a first part 38 is designed semi-circular having a larger diameter for guiding through rotary knob 34, and in the center the second part 39 of opening 33 forms a smaller semi-circular section mirror-inverted to the first part 38, by means of which the adjustment aid 29 is fixed or clamped between both rotational axes 37 of rotary knobs 34. Due to the smaller diameter of the second part 39 of opening 33 it is achieved that it is equal or larger than the outer diameter of the rotational axes 37 for rotary knobs 34, so that by the curvature of second part 39 the adjustment aid 29 is better positioned on rotational axis 37 over this section. The more accurate this section of opening 33 is adjusted to rotational axes 37, the more accurate the adjustment aid 29 will be positioned. Openings 33, particularly the first part 38 and the second part 39, are preferably designed mirror-inverted, whereby it is achieved that the foil 30 can be clamped between two rotational axes 37. For fixation foil 30 is significantly bent in the center so that rotary knobs 34 will each be guided through the first part 38. Subsequently, each second part 39 of foil 30 is pressed on the surface of input and/or output unit 18 below rotary knobs 34 to the rotational axis 37 so that foil 30 is clamped in.

In FIG. 3 a standard input and/or output unit 18 of a component of welding device 1 is shown. Here two rotary knobs 34 with one rotational axis 37 each are shown. The rotary knobs 34 are usually each assigned with a scaling 40 printed on the surface of the input and/or output unit 18. In this embodiment one rotary knob 34 for the wire feed speed—indicated with a scaling 40 in ipm or m/min—and another rotary knob 34 for the voltage—indicated with a scaling 40 in V—is provided. In addition, buttons 41 for selecting parameters and display elements 42 in the form of LEDs and LCD or 7-segment-displays are arranged, wherein appropriate imprints 43 for indication of parameters or adjustment possibilities are provided, so that with appropriate selection the appropriate displays start to illuminate or appropriate values are displayed. In such an input and/or output unit 18 the user is limited to the information provided and needs to make an appropriate adjustment of welding process with said information.

In the embodiment shown an adjustment aid 29 is used by which the user for example only needs to adjust material thickness—indicated with mm—on the additional scale 32 of foil 30. Now the user can see the scaling 40 for the rotary knobs 34 of input and/or output unit 18 and the scale 32 of adjustment aid 29 as can be seen in FIG. 4. Preferably, the user adjusts both rotary knobs 34 to the same value for material thickness in mm corresponding to scale 32 of adjustment aid 29, whereby the right values for wire feed speed m/mm (ipm) and voltage V are automatically be adjusted. Preferably, the user can choose the appropriate materials from a plurality of different adjustment aids 29 and clamp the adjustment aid 29 on the input and/or output unit 18. Adjustment aids 29 are for example labelled with information 31, such as material, e.g. steel, wire diameter, e.g. 1.0 mm and protective gas, e.g. CO₂ 100%. Each adjustment aid 29 has a scale 32 adjusted to the application so that an easy adjustment can be achieved. The appropriate adjustment aid 29 is easily to be fastened on the input and/or output unit 18 as shown in FIG. 4.

In practice, auxiliary tables for weldings are often found in the manual or printed on a housing cover, enabling the user to make such adjustments. The disadvantage here is that the user always needs to take the manual with him/her or to open the cover of the welding device 1 to get the new values for a different sheet thickness. In the adjustment aid 29 according to the invention such tables are realized in the form of scale 32 and provided to the user as practical support by simple mounting. So, a flexible surface or adjustment information of the input and/or output unit 18 is obtained as well as a simple way of adjustment.

Thus, adjustment aid 29 has the object to provide the user with additional information and, hence, to facilitate the adjustment of welding device 1. Also, in a simple manner the user can mount various adjustment aids 29 on the input and/or output unit 18 depending on the welding or application to be performed. Hence, by appropriate adjustment aids 29 a standard welding device 1 can be adjusted to the needs of a user. It is also possible that the user mounts a completely non-labelled transparent adjustment aid 29, then performs test weldings and indicates or labels own adjustments with a pen, so that he can repeat said adjustments again and again. Foil 30 can also be designed opaque, so that any section of the input and/or output unit 18 is covered and only scale 32 that is printed on foil 30 is visible. In this case, also a scale 32 for the welding current can for example be imprinted, so that an appropriate value for the current can for example be adjusted with the help of the rotary knob 34 for the voltage.

Of course the openings 33 can for example reach to the lower edge of the element or foil 30, so that it can be elided on from above between the surface of the input and/or output unit 18 and the rotary knobs 34 instead of being mounted over rotary knobs 34. It is also possible not to fasten the element or foil 30 on a rotary knob 34 or the rotational axis 37, but on special fastening points of the input and/or output unit 18. When using a touchscreen as input and/or output unit 18 an adjustment aid 29 according to the invention can also be applied, in which the element or foil 30 is designed very thin, so that, nevertheless, the touchscreen behind can be used. Furthermore, guiding rails can be arranged on the lateral edge of the input and/or output unit 18, into which foil 30 can be elided or inserted in.

Within adjustment aid 29 the electronic information thereof can also be stored, which can be retrieved from the input and/or output unit 18. So, it is for example possible to position a transponder on the adjustment aid 29 and a corresponding reader within the input and/or output unit 18 or the housing 11 of welding device 1, so that the transponder is read out when positioning the adjustment aid 29 on the input and/or output unit 18. Said information can then be provided to control device 4. Furthermore, a chip for storing data can be arranged on adjustment aid 29. Retrieving of data can be performed contactless. For this purpose, a reader can be incorporated in welding device 1 or connected to welding device 1, so that the user first approaches the adjustment aid 29 to the reader before positioning it, whereupon the chip is read out.

Adjustment aid 29 can for example be designed for different countries, such as USA, in “inch” instead of “mm”. Instead of the sheet thickness of workpieces also current values can be imprinted, so that the selection of parameters is done via a current scale. It is also possible that marking areas such as areas for good values or “lines on front foil” are provided, whereby the operating interface will not be affected negatively. Naturally, it is also possible to design and employ still other types of adjustment aid 29, particularly the information 31 and scale 32 indicated thereon.

So, a preferably transparent or semi-transparent and preferably imprinted foil 30 is arranged over adjustment elements or rotary knobs 34 on a certain user interface or an input and/or output unit 18. Foil 30 preferably sustains automatically due to the “mount and clamp system” on the input and/or output unit 18. Foil 30 was preselected due to various criteria, particularly wire material used, wire diameter and gas. Thus, reference values for adjusting rotary knobs 34 are obtained, in order to obtain a good welding result. Said reference value depends on the thickness of the sheets to be welded.

In summary, it can be said that the adjustment aid 29 is basically used to enable the user to adjust a preferred parameter quickly and easily. Values for this parameter are to be adjusted according to scale 32. Accordingly, values of scale 32 relate to scaling 40, so that the desired welding result is achieved. Naturally, the adjustment aid 29 according to FIG. 2 can also have one scale 32 only so that values of scaling 40 of the input and/or output unit 18 are adjusted on one rotary knob 34 and on the other rotary knob 34 values of scale 32 are adjusted.

1. An adjustment aid (29) for a component of a welding device (1) in the form of an element for mounting or fastening on an input and/or output unit (18) of said component, on which element additionally information (31) and/or scale (32) for adjusting a welding process are printed, wherein the element is formed by a flexible element or a foil (30) with two openings (33) for mounting or fastening to two rotary knobs (34) of the input and/or output unit (18), each opening having a first part (38) and a second part (39), wherein the first part (38) of each opening (33) is designed for guiding through one rotary knob (34) and the second part (39) of each opening (33) is formed for fixation between the two rotational axes (37) of the rotary knobs (34).

2. An adjustment aid (29) according to claim 1, wherein the first part (38) and the second part (39) of each opening (33) are each designed semi-circular, wherein the diameter of the first part (38) is larger than the diameter of the second part (39) and the first part (38) is arranged mirror-inverted to the second part (39).

3. An adjustment aid (29) according to claim 1, wherein the flexible element or foil (30) is labeled with information (31), such as material, e.g. steel, wire diameter, e.g. 1.0 mm, or protective gas, e.g. 100% CO₂, and has a scale (32) adjusted corresponding to the component used.

4. An adjustment aid (29) according to claim 1, wherein in case of the adjustment aid (29) mounted or fastened a scaling (40) for the rotary knobs (34) of the input and/or output unit (18) and a scale (32) on the flexible element or foil (30) can be seen.

5. An adjustment aid (29) according to claim 1, wherein the scale (32) is designed such that on both rotary knobs (34) the same value, for example the value of a material thickness of the work pieces (14) to be welded in mm is to be adjusted.
